(19) United States
(12) Patent Application Publication
(10) Pub. No.: US 2018/0360013 A1
(43) Pub. Date: Dec. 20, 2018

(54) FISHING LURE TROLLING SPREADER BAR

(71) Applicant: Steven Edward Breunig, Marmora, NJ (US)

(72) Inventor: Steven Edward Breunig, Marmora, NJ (US)

(21) Appl. No.: 15/969,448

(22) Filed: May 2, 2018

Related U.S. Application Data
(60) Provisional application No. 62/522,182, filed on Jun. 20, 2017.

(51) Int. Cl. A01K 91/08; A01K 85/00

(52) U.S. Cl. CPC A01K 91/08; A01K 85/00

(57) ABSTRACT

A keel attached to a central body of trolling spreader bar is configurable with a plurality of fishing lures as an assembly to mimic a small school of fish or a dredge/umbrella rig. The keel is angled to urge the lure assembly continually to one side or the other from what would be the normal straight line of travel of a trolling vessel. By attaching an angled keel directly to the lure/spreader bar one is able to easily set lines behind the vessel at varying angles and distances which greatly increase the width of the full trolling lure spread.

### CROSS-REFERENCE TO RELATED APPLICATION

This application claims the benefit of priority of U.S. provisional application No. 62/522,182 filed Jun. 20, 2017, the contents of which are herein incorporated by reference.

### BACKGROUND OF THE INVENTION

The present invention relates to fishing lures, and more particularly to spreader bars used to separate a plurality of fishing lures while trolling.

When trolling, a plurality of lures may be extended behind the trolling vessel. Lures being trolled behind a boat will basically track a straight path behind the point they are pulled from (rod tip or outrigger release). This limits the total width of water that may be covered by the fisherman's lures, which in turn limits the number of fish that see and therefore may strike the lures. Lures that run very wide from the boat are running in “clean water”, which is water that is undisturbed by the boat's engine turbulence/bubble trail and wake. “Clean water” provides better visibility of the lures as well as a more natural setting to the predator fish who do most their feeding in natural “clean water.”

Prior to this invention the only means available to widen the path of trolled spreader bar lures are outriggers (attached to the boat), planer boards and out-rovers. Outriggers are costly and are limited in their extension length from the sides of the trolling vessel. Similarly, planer boards have been utilized. Planer boards are not attached directly to the lure for ease of use. Instead the fishing line is attached to the planer board by a release clip and then to a lure tracking well behind the planar board. Planer boards are also limited as they are typically used in calm bay like conditions and do not function well in rough ocean like conditions. Out-rover devices use a combination of keel and rudder which causes them to be large and bulky, which inhibits them from imitating natural bait(fish/squid) well, which in turn limits their effectiveness to catch fish.

As can be seen, there is a need for an improved system and method for trolling that increases the spread width, and thereby the number of lures that may be pulled behind a trolling vessel while fishing. By increasing the spread width of the lures a vessel will expose his lures to a greater number of fish and therefore more opportunities for fish to see and strike the lure.

### SUMMARY OF THE INVENTION

In one aspect of the present invention, a trolling spreader bar includes an elongate central body, a spreader bar that extends laterally outward from the central body, and a keel that extends from a ventral surface of the elongate central body at an angle relative to a longitudinal axis of the central body. The trolling spreader is configured such that the central body is guided laterally outwardly from the direction of travel of the trolling spreader bar while trolling.

In a preferred embodiment of the invention, the keel angle is adjustable relative to the longitudinal axis of the body. The central body may also include a second keel extending from a dorsal surface of the central body. A lateral fin may also be provided to extend outwardly from the central body. The lateral fin may be adjustable about a lateral axis of the central body to control a depth at which the trolling spreader bar may travel when trolling.

In some embodiments, the spreader bar also includes a first rod and a second rod that extend laterally from the central body. A first bait lure may be attached to an end of the first rod and the second rod. The first rod and the second rod may be configured to have an aft sweep.

In other preferred embodiments, a plurality of bait lures are interconnected to the first bait lure by a line extending between an aft end of a preceding bait lure and a front end of a succeeding bait lure. At least an outboard one of the first bait lure further comprises a counterweight. The counterweight may be carried within a body of the first bait lure. The plurality of bait lures may also include a plurality of hooks adapted to receive a live bait.

In other aspects of the invention, a trolling spreader bar is provided with an elongate central body, and a keel attached to a ventral surface of the elongate central body. A spreader bar extends laterally outward from a left side and a right side of the central body. A first bait lure is attached to a first end and a second end of the spreader bar.

In some embodiments, a counterweight is attached to at least an outboard end of the spreader bar, relative to a direction of travel of the spreader bar in a body of water. The counterweight may be the first bait lure. The counterweight may also be carried within a body of the first bait lure.

In preferred embodiments, the keel angle is adjustably attached relative to the longitudinal axis of the body. A second keel may also extend from a dorsal surface of the central body. In other embodiments, a lateral fin extending outwardly from the central body. The lateral fin is preferably adjustable about a lateral axis of the central body to control a depth at which the trolling spreader bar may travel when trolling in the body of water.

In yet other aspects of the invention, the plurality of bait lures interconnected to the first bait lure by a line extending between an aft end of a preceding bait lure and a front end of a succeeding bait lure.

These and other features, aspects and advantages of the present invention will become better understood with reference to the following drawings, description and claims.

### BRIEF DESCRIPTION OF THE DRAWINGS

FIG. 1 is a perspective view of a wide tracker fishing lure spreader bar.

FIG. 2 is a schematic view of a plurality of the wide tracker fishing lure spreader bar shown in use in a trolling array.

FIG. 3 is a top plan view of the fishing lure spreader bar.

FIG. 4 is a front elevation view of the fishing lure spreader bar 10 in use, shown with a waterline 30 shown in dashed lines.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method and apparatus for trolling that improves the spread, and thereby the number of lures that may be pulled behind a trolling vessel while fishing. By attaching an angled keel 14 or rudder directly to a lure/spreader bar, one is able to easily set lines behind the boat at varying angles and distances which greatly increase the width of a full trolling lure spread.

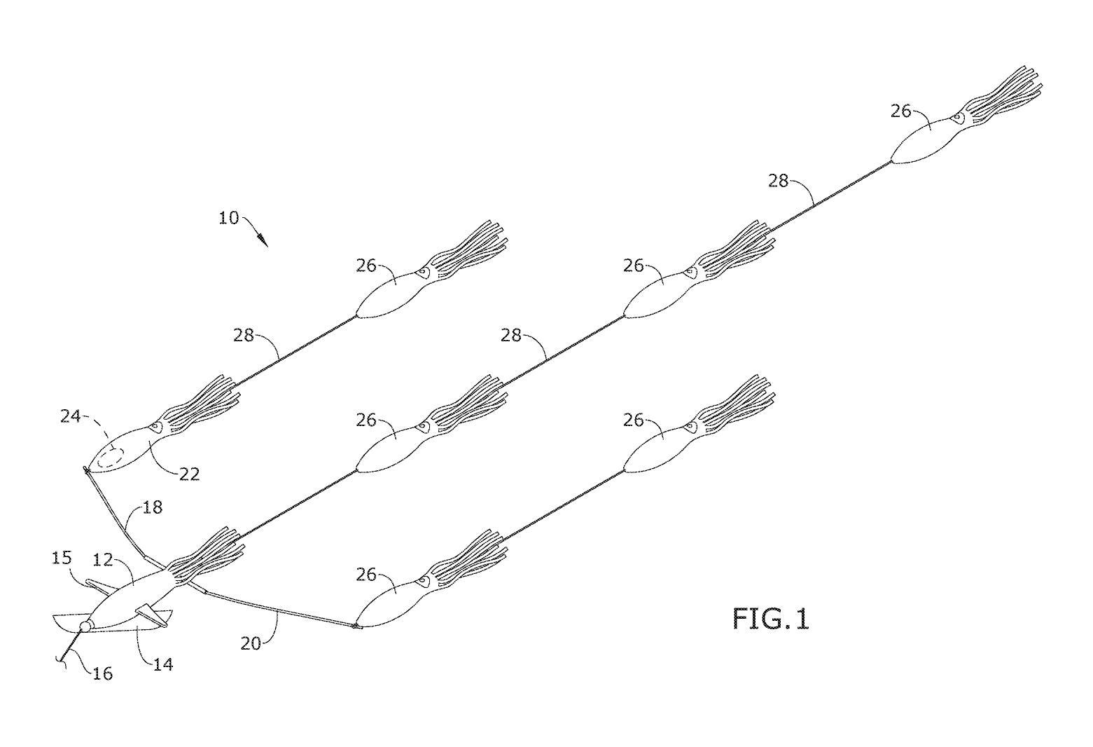

As seen in reference to FIG. 1, a spreader bar 10 according to aspects of the invention is shown. The spreader bar 10 includes an elongate central body 12, or hub and a spreader bar 10 or rod 18, 20 that extends laterally from the central body 12, or hub. The central body 12 may be in the form of a fish bait. The central body 12 has a keel 14 that extends from the central body 12 at an angle relative to a longitudinal axis of the central body 12.

The keel 14 is angled such that the central body 12 is guided laterally outwardly from the direction of travel of the fishing vessel 32 while trolling. The keel 14 angle may be adjustable relative to the body. The keel 14 may extend from a dorsal or ventral surface of the central body 12 or through the body. The central body 12 may also be configured with a lateral fin 15 to improve longitudinal stability and provide planeing lift. Additionally, the lateral fin 15 may be adjustable to control the depth at which the lure assembly may travel when trolling.

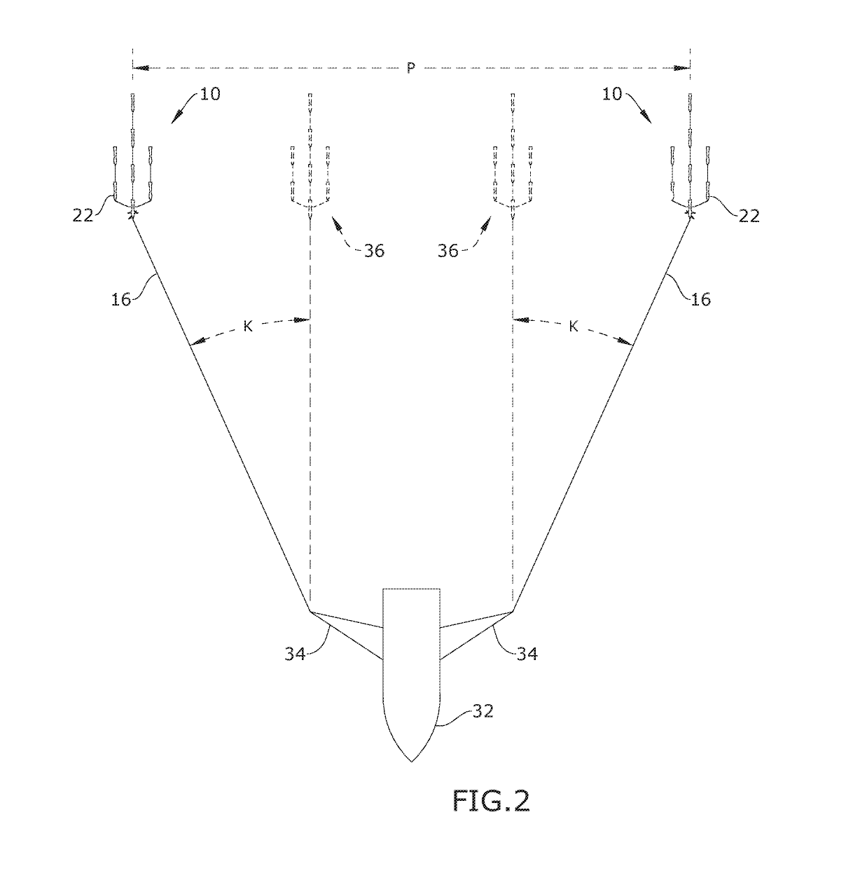

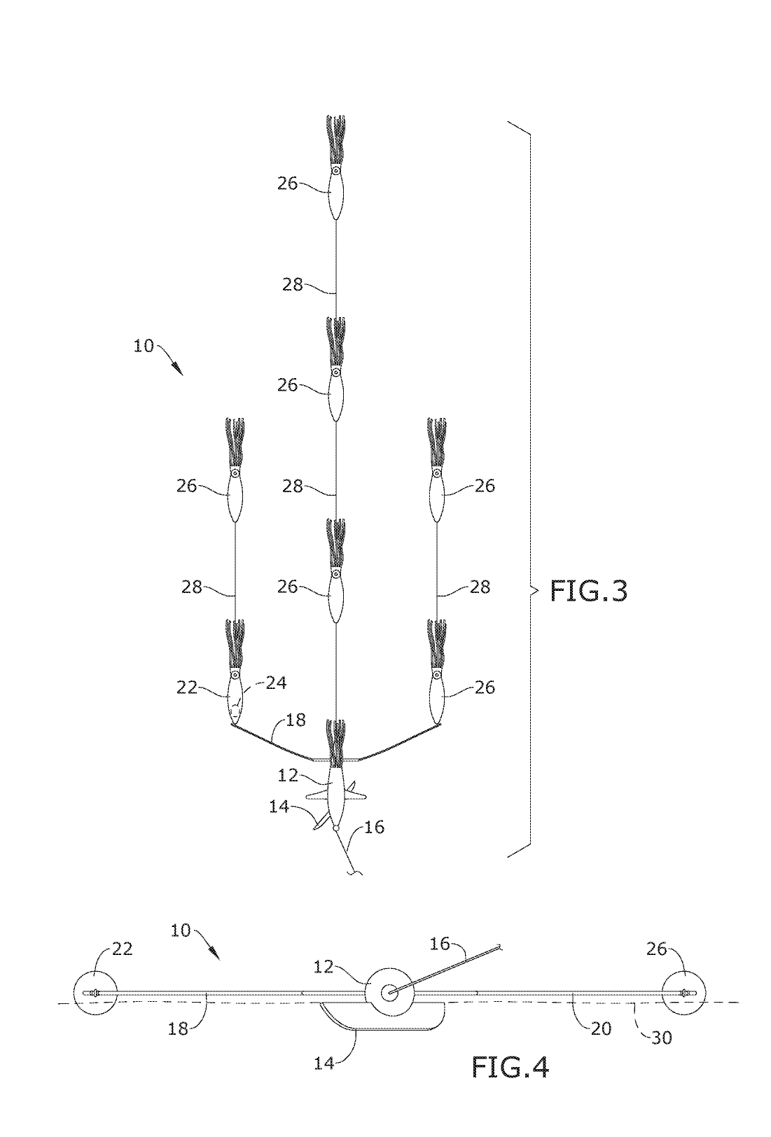

As seen in reference to FIG. 2 a trolling configuration for a fishing vessel 32 according to aspects of the invention is illustrated. The trolling vessel 32 may be configured with a plurality of outriggers 34 extending laterally from the starboard and port sides of the vessel 32. With a typical spreader bar 10, the fishing lines 16 extend in a straight path from the stern of the vessel 32 and its direction of travel. The spreader bar 10 is configured with a plurality of lures 26 disposed in a spaced apart relation to replicate the schooling habits of a bait fish. The lures 26 are configured with one or more hooks so as to catch a game fish that may strike the lure 26. The lures 26 may also include a hooked natural bait, such as a squid, a crustacean, a baitfish, and the like.

As will be appreciated, a plurality of fishing lines 16 each carrying the aforementioned spreader bar 10 and lures 26 may be extended from the stern of the vessel 32. This enhances the ability of the trolling vessel 32 to replicate a large school of bait fish and thereby provide better opportunities to attract and catch a game fish. When employing a spreader bar 10 lure assembly according to aspects of the invention, the lures 26 carried by the spreader bar 10 are urged outwardly by the keel 14 as the trolling vessel 32 pulls the spreader bar 10 through the water.

The spreader bar 10 has a first rod 18 and a second rod 20 that extend laterally from the central body 12 and may have a rearward sweep. A bait lure 26 may be operatively attached to ends of the first rod 18 and second rod 20. In addition, a plurality of bait lures 26 may be interconnected by a line 28 extending between an aft end of a preceding bait lure 26 and a front end of a succeeding or following bait lure 26 so as to replicate a school of fish bait, such as bait fish, mollusks, worms, squid, crustaceans, and the like.

In operation the angle keel 14 directs the lure/spreader bar 10 to one side or the other of the trolling vessel. Depending on the trolling velocity and weight of the spreader bar 10 and associated lures, the water pressure exerted on the angled keel 14 may cause the lure to become un-level and unstable as it is drawn through the water. Accordingly, a counterweight 24 may be provided to act against this pressure and keeps the lure level while tracking through or across the top of the water. The counterweight 24 may be operatively coupled to the first end or the second end of the spreader bar 10. Preferably the counterweight 24 is carried within the body of a bait lure 26 attached to the first and second ends of the spreader bar 10. In a preferred embodiment, the counterweight 24 is carried on the outward end of the arm 18. 20 relative to the lure assembly's 10 direction of travel so as to counteract the pressure applied to the angled keel 14. The body of the lead inboard lure 26 facilitates leveling as it planes on the water surface. The trailing lure bodies 26 serve to drag the rig and prevent “walking” or flipping of the rig in the water.

In use, the fisherman would attach an angled keel 14 lure/spreader bar 10 to his fishing line 16. The fisherman may then cast or while the vessel 32 is moving forward let the lure assembly 10 out behind the vessel 32. When tension is applied to the fishing line 16 the angled keel 14 would direct the lure assembly off of its normally straight path to a new position laterally to the side of the vessel's 31 path of travel. Therefor solving the problem of only having lures 26 dragging directly behind the pulling point on the vessel 32. He would instead have lures 26 tracking well out to each side of the vessel 32 running in clean water giving him a wider spread of fish bait for more game fish to see and strike. As will be appreciated, the angled keel 14, stabilizing counter weight and corresponding lifting bait can be applied to surface trolling lures 26 such as umbrella rigs and dredges. By attaching an angled keel 14 directly to the lure/spreader bar 10 one is able to easily set lines behind the vessel at varying angles K and lateral separation P, which greatly increase the width of the full trolling lure spread.

It should be understood, of course, that the foregoing relates to exemplary embodiments of the invention and that modifications may be made without departing from the spirit and scope of the invention as set forth in the following claims.

What is claimed is:

1. A trolling spreader bar, comprising:
an elongate central body;
a spreader bar that extends laterally outward from the central body; and a keel that extends from a ventral surface of the elongate central body at an angle relative to a longitudinal axis of the central body, such that the central body is guided laterally outwardly from the direction of travel of the trolling spreader bar while trolling.

2. The trolling spreader bar of claim 1, wherein the keel angle is adjustable relative to the longitudinal axis of the body.

3. The trolling spreader bar of claim 1, further comprising:
a second keel extending from a dorsal surface of the central body.

4. The trolling spreader bar of claim 1, further comprising:
a lateral fin extending outwardly from the central body.

5. The trolling spreader bar of claim 4, wherein the lateral fin is adjustable about a lateral axis of the central body to control a depth at which the trolling spreader bar may travel when trolling.

6. The trolling spreader bar of claim 1, wherein the spreader bar comprises a first rod and a second rod that extend laterally from the central body.

7. The trolling spreader bar of claim 6, further comprising:
a first bait lure attached to an end of the first rod and the second rod.

8. The trolling spreader bar of claim 6, wherein the first rod and the second rod have an aft sweep.

9. The trolling spreader bar of claim 6, further comprising:
a plurality of bait lures interconnected to the first bait lure by a line extending between an aft end of a preceding bait lure and a front end of a succeeding bait lure.

10. The trolling spreader bar of claim 9, wherein at least an outboard one of the first bait lure further comprises a counterweight.

11. The trolling spreader bar of claim 10, wherein the counterweight is carried within a body of the first bait lure.

12. The trolling spreader bar of claim 11, wherein the plurality of bait lures comprises a plurality of hooks adapted to receive a live bait.

13. A trolling spreader bar, comprising:
an elongate central body, a keel attached to a ventral surface of the elongate central body;
a spreader bar extending laterally outward from a left side and a right side of the central body; and
a first bait lure attached to a first end and a second end of the spreader bar.

14. The trolling spreader bar of claim 13, further comprising:
a counterweight attached to at least an outboard end of the spreader bar, relative to a direction of travel of the spreader bar in a body of water.

15. The trolling spreader bar of claim 14, wherein the counterweight is the first bait lure.

16. The trolling spreader bar of claim 15, wherein the counterweight is carried within a body of the first bait lure.

17. The trolling spreader bar of claim 1, wherein the keel angle is adjustably attached relative to the longitudinal axis of the body.

18. The trolling spreader bar of claim 17, further comprising:
a lateral fin extending outwardly from the central body.

19. The trolling spreader bar of claim 18, wherein the lateral fin is adjustable about a lateral axis of the central body to control a depth at which the trolling spreader bar may travel when trolling in the body of water.

20. The trolling spreader bar of claim 19, further comprising:
a plurality of bait lures interconnected to the first bait lure by a line extending between an aft end of a preceding bait lure and a front end of a succeeding bait lure.
